(19) United States
(12) Patent Application Publication
(10) Pub. No.: US 2011/0121593 A1
(43) Pub. Date: May 26, 2011

(54) FLEXIE STROLLERS

(75) Inventor: Mahmuda Susan Yildiz, Smithtown, NY (US)

(73) Assignee: Mahmud Susan Yildiz, Smithtown, NY (US)

(21) Appl. No.: 12/623,521

(22) Filed: Nov. 23, 2009

(51) Int. Cl. B62D 39/00

(52) U.S. Cl. 296/1.07

(57) ABSTRACT

The Flexie Stroller(s) do comes with unique functional features in its all wheels (fronts and the backs); push handle, adjustable seats with head support, and unique addition to bars for kids' drinks, cargo area and exceptional element for children's' toy (teddy bears or dollies). Wheels are height adjustable, Push handles are extendable, Trays are more useful and cargo area can carry additional stuff in without clasping. Seats are adaptable for better comfort. Especially very charming piece of art for children's toys can add value and piece of mind for parents and care givers. The invention does apply to any kind of strollers, double, triple, side by side or back to back and even the single strollers.

### BACKGROUND

The invention of the FLEXIE STROLLER is all about convenience, safety and health for the environments, to all users, parents, care givers and especially for children. These issues are not covered in the past and currently existing strollers. The Flexie Strollers are useful for all type of users' men/women and children in any height level tall or short. Yet, this invention is may be vary first stroller where actually some one did add so much great improvement all at once. Definitely the FELXIE STROLLE is very handy to all people for all ages and gender and it is especially favorable for children. It is defiantly economic and good to the environment.

### PRIOR ART

Users of currently exiting strollers will find them self and their children not comfortable while using the strollers. When kids are fallen a sleep during the ride currently exciting stroller their little, tiny heads falls off to the side of the strollers. The seats are not comfortable for kids to be able seated all times. Kids' feet are not comfortable Users are not relaxed while ridding currently existing stroller because of its low heights and it is inefficiency. The low height is not healthy for taller parents, users and caregivers, and who are wearing high heals during the ride. Kids are not sitting quite during the travel because there is no room for their favorite toys. Users are not able to store too much or a little heaver items underneath the stroller in cargo, because the bottom of the storage areas is not supported to prevent from damages. Because of the fact that currently existing strollers are not user friendly the consumers must keep changing to buy each time a new one, when their stroller becomes not useful to them anymore. And this matter will cause to damage to the environments and adds more trash to the landfills.

### SUMMARY

As a tall female and a mother of two young children my self we are using the stroller almost every single day in our lives. My kids are my inspiration of this invention. Each time when I used the stroller and watched my daughters, that they are not enjoying their ride on the stroller I come up with new improvement ideas and a new invention to make my kids life and all consumers living a lot safer. I guess I created and invented some thing nice for our children and preferable to our friend earth and the environment. This invention will make peoples' life a lot safer and easier then ever. It is protected, convenience, safe and healthy for children, consumer and the environment.

This invention can bring lots of saving for users, which allows consumers to use the Flexie Strollers for longer period of time then usual. It can be used since the baby was born until the child becomes a big kid.

This invention protects the environment. Users don't need to keep buying each time one new stroller to fit the child's need. It is economic to every one's budget. This means less trash and less unwanted dumpster for the environment.

The beauty of present invention is that all of claims can be add on to the stroller at once or can be include separately as needed. It is may be the very first stroller of all times, which can offer so much convince, functionality and safety for parents, caregiver and especially for our children.

From the figures, the descriptions, and claims this invention's technical advantages are apparent. Flexie Strollers are rocking strollers of all times.

### DRAWING

### Figures

Embodiments of this invention can be understood further by referring to the following descriptions and accompanying drawings.

NOTE: Please note that the drawings are based on Stroller's perspective view.

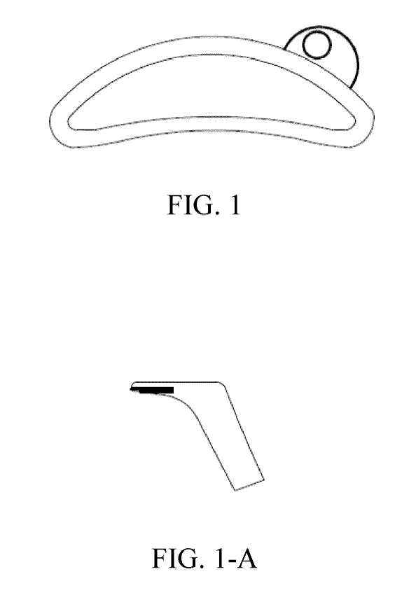

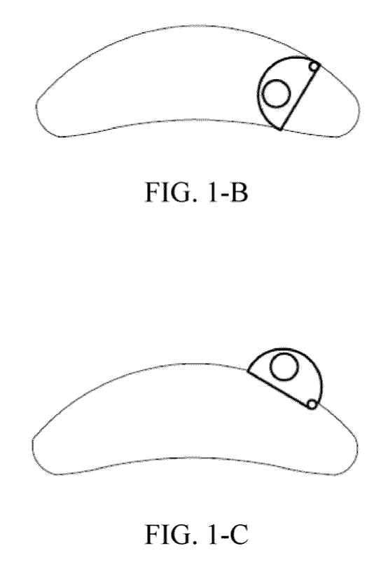

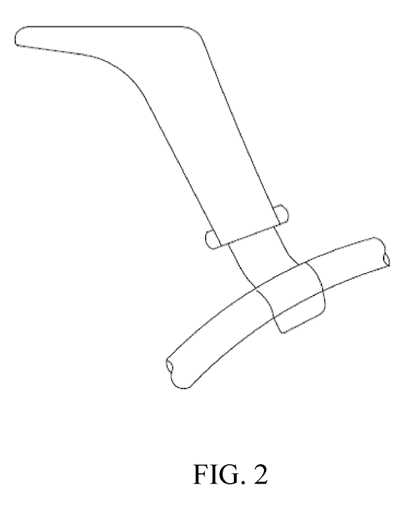

FIG. 1. Shows the full view of the bar with wing extensions from the top.

FIG. 1-A. Shows the sides view of the bar with the wing closed underneath the bar.

FIG. 1-B. Shows full view of the wing from the bottom on the bar in closed position.

FIG. 1-C. Shows full view of the wing extensions from the bottom in open position.

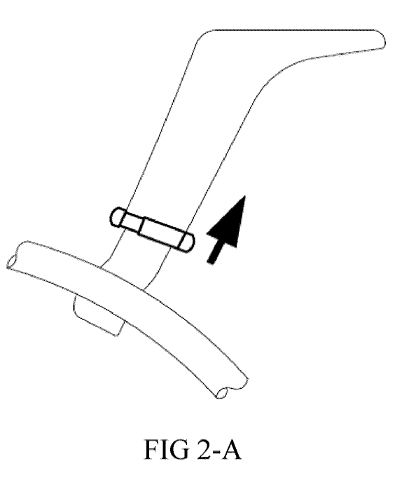

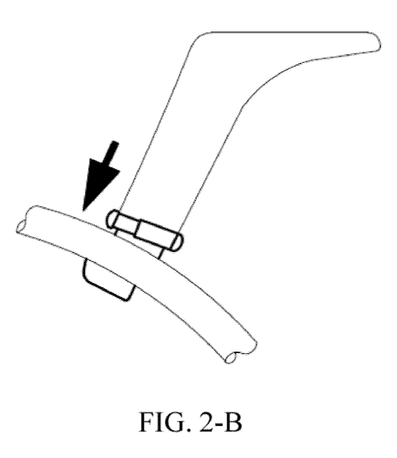

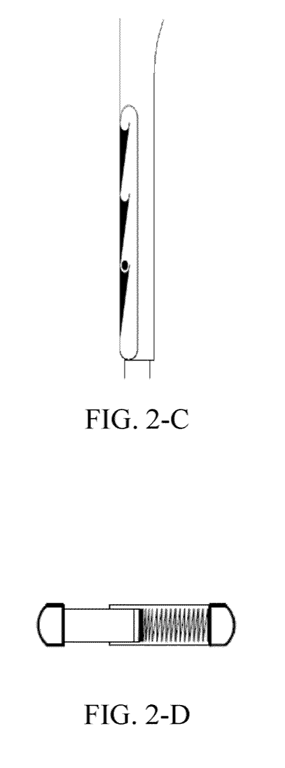

FIG. 2. Shows the full front view of bar with the Extension.

FIG. 2-A. Shows full back view of bar Extension in Open Position.

FIG. 2-B. Shows full back view of bar Extension in Closed Position.

FIG. 2-C. Shows side view of bar with teeth where the cylinder can slide in and out to make the movement or bar extension possible.

FIG. 2-D. Shows the view of Cylinder Tube, which is used to make the process of bar extension possible.

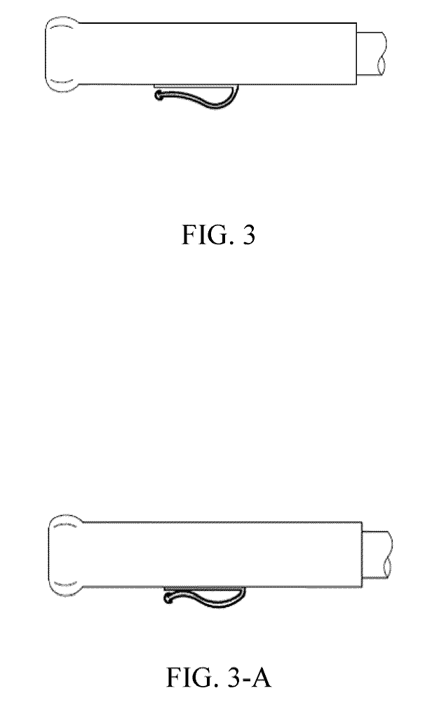

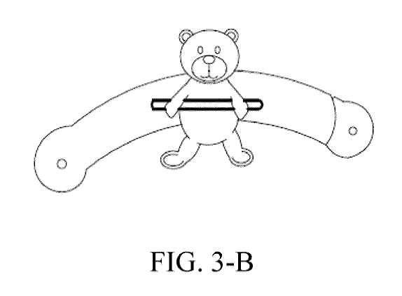

FIG. 3. Shows full view of Teddy Bear/Dolly Holder from the top in Open Position.

FIG. 3-A. Shows full view of Teddy Bear/Dolly Holder from the top in Closed Positions.

FIG. 3-B. Shows full view of stuff animal/dolly holder from side with an object/teddy bear in side the ring holder.

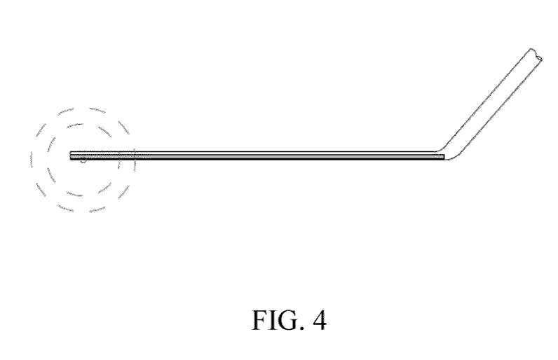

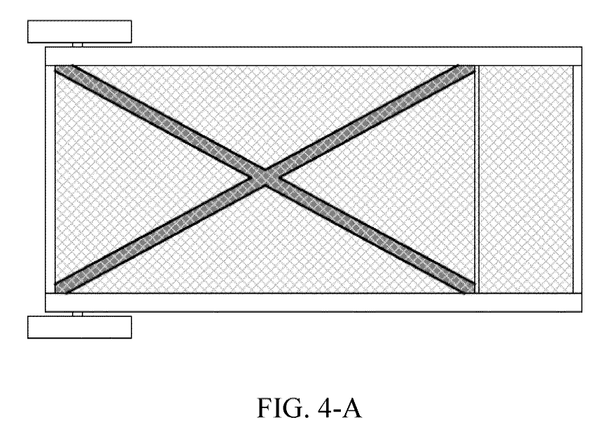

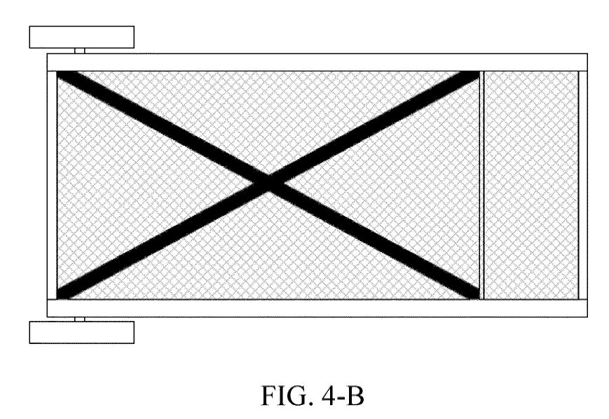

FIG. 4. Shows side view of Cargo Area with Cress Crosse.

FIG. 4-A. Shows full view of Cargo Area from the Top with Cress Crosse.

FIG. 4-B. Shows full view of Cargo Area from the Bottom Cress Crosse.

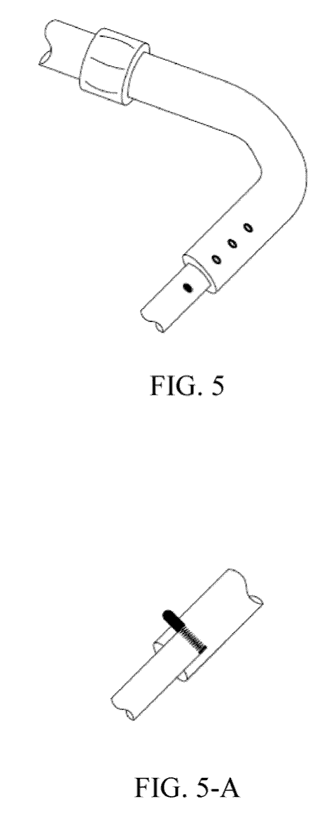

FIG. 5. Shows full view of Push Bar Handle with Extension.

FIG. 5-A. Shows Inside View of push bar handle with Extensions.

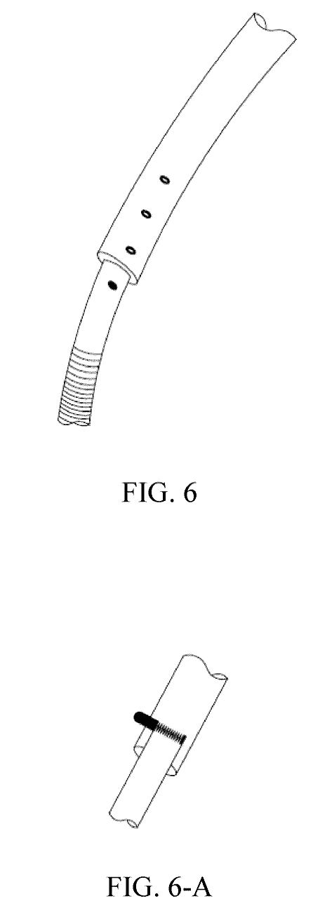

FIG. 6. Shows Full View of Leg Extensions with Addition

FIG. 6-A. Shows Inside View of Leg Addition with Extensions.

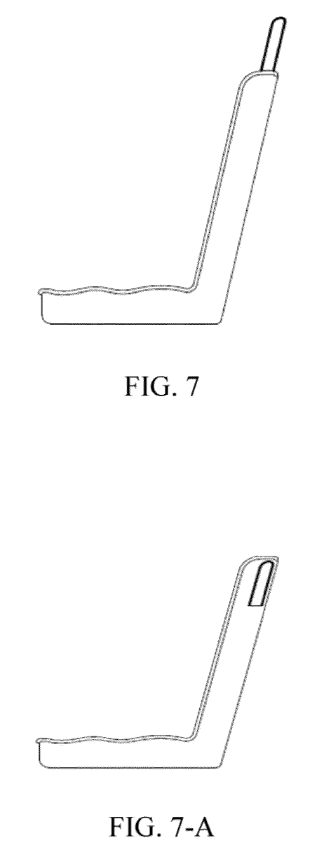

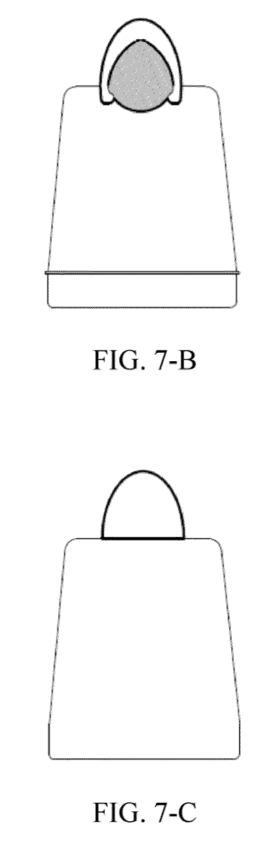

FIG. 7. Side View of Head Support/Pillow in Open Position.

FIG. 7-A Side View of Head Rest/Pillow in Closed Position.

FIG. 7-B Full Front View of the head rest/pillow while it is Open.

FIG. 7-C Full Back View of the head rest/pillow while it is Open.

Drawings are based on double stroller back to back, which I have referred entire sketches for this particular type of strollers.

### DRAWINGS

### Reference Numerals

TABLE-US [0001-0033] 1. Views of the Try/Bar(s) 2. Views of Bar(s) extension(s). 3. Views of Dolly/Teddy Holder(s). 4. Views of Cargo/storage(s) Unit. 5. Views of Handle Extension(s). 6. Views of Leg extension(s). 7. Views of Head Rest/Pillow Protector(s). Please note the drawings descriptions are based on Stroller's perspective view.

### DETAILED DESCRIPTION

Embodiments of the present invention are understood best while referring to the FIGS.

FIG. 1-FIG. 1-C: It represents the full view of the bar(s)/trays in front of each seat, where it comes out under the bar for use. It is smaller piece of plastic material like the rest of stroller to place children's drinks. On this particular type of stroller it is visible only if it is needed. It is hocked with a small piece of pin at the top piece the actual tray. The wing can be round or oval depend the original design of bars/trays. In an event if the bar/tray is narrow the oval ship is most likely recommend. Other wise the round ship for drinks is more suitable shape.

the size of this wing/additional room or extension is about 5×5″ in round shape and 5×7″ in oval shape. And it is hocked to original bar with a ½ inches tall screw/pin, which allows this additional wing to function properly. And the size of hole of the cup holder would be 3-3½″ wide and the gap is standard size for any type of cups.

This is a fine function on this invention, which gives more room for children, parents and care givers to not be worry about spilling and things at that nature. It keeps drinks safe in its place away from the tray/bar and child's feet.

Especially this quality allows child's legs would be more relaxed because their wouldn't be any drinks near their legs to border them and it will be safe for the child and drink to be at right spot all times. It is absolutely a great new useful addition for strollers' world.

FIG. 2-FIG. 2-D: It is a complete views of bar(s) in front seats, where it is most appropriate for Todd's. It gives more comfort for taller children with longer legs to be seated comfortably on their places during the ride.

There are two allotments on both sides of each bar. One is lager which is the top portions and narrower part, which the bottom piece and it is hocked to the railing walls. The process works with use of long tube cylinders with push buttons on each side, which is attached to the narrower part (bottom portions of the bar).

The cylinder it self is made of two portions as well as the bars. One is wider then other. The wide part is about ½″ broad and narrower part is about 0.47″ less then half inches wide. This allows making the move by pushing the two push buttons on each head of the cylinder. This size of push button are just about ½.05″ inches diameter a little bigger the size of the tube it self, which allows users to make the height adjustments to the bar trays.

The Length of the cylinder tube is about 4″ long and it is attached to edge of the narrower bottom portions of the bars. The sizes of push buttons are just about the same as the wideness of the cylinder a little bigger ½.05″ wide. Please, note the wideness of bars wide is based on manufacture's item. It could be wider or narrower depends on the type of strollers.

The cylinder it self is made of two parts wider and narrower. There is a small piece of spring inside the wide part of the tube and this spring allows users to make the move possible by pushing the push buttons on each side of the cylinder. The size is spring is just about 2″ long and it is hocked at the end of narrower part of the tube.

The teeth are located on the top portions the wider part of the bars/trays. There are three levels for the comfort move. Users can adjust the height of their Flexie Strollers as needed up to 3″ inches high. The process function that user clicks the push bottoms and holds then places at the approach tooth.

On the above teeth each tooth is almost 1″ inches apart from one another. Each move takes the user to adjust the height of their stroller up to one inch higher. The size is each tooth is big enough that push buttons can fit easily in to and stays tighten. The teeth sizes are as the same as the push button size less then 1″ inches.

FIG. 3-FIG. 3-B: The full view of dolly or teddy bears holder from the above. The hock is made of hard martial such as hard plastic like the rest part of the stroller or made of light weight metal for better hold. It can be screwed to the side of the stroller or glued. And for the safety reasons there would be a piece of plastic protection just like safety at corners on each hock's end.

The size of half U ship teddy bear/dolly holder is about 4×3″ diameter. The thickness of the whole piece is not more then 3 mml. And the sizes of plastic protectors at the ends are also about 0.25″ Qtr inches just to fit to the edges of each piece. The notch size is 2″ wide. The dolly or teddy bears can be pushed in trough the notch then hock hold kids favorite toys safely during the ride.

There is a hitch on the end, which allows user to close the teddy bear/dolly holder when is not in use. The dolly/teddy holder are flexible and can be pushed down on the side while is not in use. This unique piece can be made of flexible light weight metal, stainless steal or hard plastic for better functionality and durability.

FIG. 3-B This view represents the side view of dolly/teddy bear holder hock with an object inside the hole. It is the most cuties additions which adore each child's wish.

FIG. 4-FIG. 4-B: These views show the bottom of the cargo area, where there are two pieces of metal are sit cress cross. The metals are covered with sleeves and attached on all corners. The sleeves are made out the fabric just like the rest part of strollers. And the cress cross are made of metals for better performance.

The cross are protectors and keeps stuff in more secure and safer then before. The size is about 1″ wide and lent on this particular back to back stroller is about 12″ long. Again, please, note that length is varying based on manufacture's article. It could be shorter or longer, but the wideness is the same in all types of strollers. The cress cross bars are located at the bottom of the cargo area and allows users to store more stuff at the bottom of the strollers It also can be made of strong plastic or piece of light weight metal for better hold.

FIG. 5-FIG. 5-A. Shows the handles or push bar extension, which works by clicking of a button. Once-three levels as needed.

The extension can be adjusted up to three levels about 3″ high as needed.

The round cylinder piece of metal, which can be pushed in-out during the use. It is located in smaller part of the rods on each side. It functions with help of small piece of spring underneath the metal button and it allows user to adjust the stroller's push bar handle his/her comfort level.

The size of small cylinder metal button is about quarter of an inches 0.25″round wide and half inches 0.50″height. And the size of tinny spring is about half inches 0.50″ and it has attached at the bottom of cylinder inside the narrower part of the rods.

There are three holes one inch apart from one another. The size of the hole is just the same size of the cylinder metal quarter inches wide. These holes are located at the wider rods. It allows the user to adjust the stature of push bar handle on their Flexie stroller up to three inches higher then an average stroller for better ride and comfort.

The size of small metal button is about 0.25″ Qtr inches round wide and 0.50 half inches height. And the size of tinny spring is about 0.50″ half inches.

The round piece of cylinder metal which can be pushed in-out during the use. And it is installed in side of the narrower part of the rods on each side. And gives the user extra ability to adjust the Flaxie Stroller at their comfort level. This muted function with a small piece of spring underneath of the round ship cylinder metal button, which allows user; push the button down and release at extend level for better comfort use.

The size of tinny spring is about half inches and it has attached at the bottom of cylinder inside the narrower part of the rods. There are three holes one inch apart from one another. The size of the hole is just the same size of the cylinder metal quarter inches wide. These holes are located at the wider rods. It allows the user to adjust the length of push bars of Flexie stroller up to three inches higher then an average stroller for better ride and comfort.

FIG. 6-FIG. 6-A. Shows the Leg extension in front and back, which works by clicking of a button. Once-three levels as needed.

The leg extension above can be adjusted up to three levels about 3″ high as needed.

The round cylinder piece of metal, which can be pushed in-out during the use. It is located in smaller part of the rods on each side. It functions with help of small piece of spring underneath the metal button and it allows user to adjust the stroller's height his/her comfort level.

The size of small cylinder metal button is about quarter of an inches 0.25″round wide and half inches 0.50″height. And the size of tinny spring is about half inches 0.50″ and it has attached at the bottom of cylinder inside the narrower part of the rods.

There are three holes one inch apart from one another. The size of the hole is just the same size of the cylinder metal quarter inches wide. These holes are located at the wider top rods. It allows the user to adjust the height of push bar handle on their Flexie stroller up to three inches higher then an average stroller for better ride and comfort.

The size of small metal button is about 0.25″ Qtr inches round wide and 0.50 half inches height. And the size of tinny spring is about 0.50″ half inches.

The round piece of cylinder metal which can be pushed in-out during the use. And it is installed in side of the narrower part of the rods on each side. And gives the user extra ability to adjust the Flaxie Stroller at their comfort level. This muted function with a small piece of spring underneath of the round ship cylinder metal button, which allows user; push the button down and release at extend level of height for better comfort use.

The size of tinny spring is about half inches and it has attached at the bottom of cylinder inside the narrower part of the rods. There are three holes one inch apart from one another. The size of the hole is just the same size of the cylinder metal quarter inches wide. These holes are located at the wider rods. It allows the user to adjust the height of their Flexie stroller up to three inches higher then an average stroller for better ride and comfort

FIG. 7-FIG. 7-C. These views represent the head rest/pillow. It describes how it functions while the head rest/pillow is in use conditions. The cushions can be slide inside in the back of each seats when is not in use. And can be pulled out as desired. The pillow can made from the same type of material like the rest part of the stroller. The filling must be made from very soft cotton. It is washable and reusable.

The pillows/heat rests is located in the middle at each child's seat back-rest. It is an about 7″ wide and 10″ high. It has additional 2×2″ wide round puffy boundaries to keep child's head in place during sleep. The pillow/head rest can be inserted inside of the pocket behind on the back seats when is not in use.

The pillow works in any conditions and works even better when child's seats can be adjusted about 135 degree angels for more and better relaxing position while a child is in sleep at naptime.

Head rest/pillow is made of same fabric just like the rest part of Flexie Stroller's. It is very functional and very useful and easy to meantime. The materials must be washable for better use. There is small tine wire runs around the cousin on the edges which holds the pillow in place. The size of wire is about quarter inches 0.25″ wide and goes all around the cousin on the corner. It is tighten on each edge from right to the left for better hold.

The invisible wire is located inside for better performance. And it keeps the head rest in place. Besides the middle part of the pillow is made of strong type of martial and has a cardboard inside and coved with soft cotton for child's′ head protection.

What is claimed is:

1. The Wing Component of Bar(s): The round shape drink holder is located underneath the bars in front of children. It is hidden from the view and it comes out of the bar for more convenience use as needed. Just like a wing it is a slightly flat piece, which can be pulled out for use and pushed backed in when is not used.
The bar components on claim 1, wherein this additional room allows children to hold their drinks comfortably on it's place away from their knees and it gives more room for their snacks and drinks. It is a great option for taller kids with long legs who are able to comfortably be seated without any disturbance.
The wing does function by using a small round flat shape knob underneath actual main bar, which allows moving in or out as needed.

2. Bar(s) Height Expansion: This feature allows user to extend the height of the bar proper for child's need up to three levels, which children can feel more comfortable and are able to put their legs over the foot holder at the bottom without bending their legs or hanging out to the floor. The children can feel more comfy and are able to ride more relaxed on their seats.
The Flexie Strollers where the bar height expansion on claim 1, wherein the thinner part is hocked to slid inside of upper wider main part of the bar. There are three levels where users can adjust the height as needed. It functions by use of narrow cylinder with small push bottoms on each end.

4. Stuff Animals/Dolly Holder: A hock a special, flexible and unique receptacle allows kids to keep their favorite Stuff Animals or Teddy Bears and dollies just on the right spot for show off.
The stuff animal and dolly holder on claim 2, wherein located at the right or left based on the type of stroller. It can be placed on either sides of each seat of the Flexie Strollers. The hock can be pushed to sides when is not needed. This option on this invention does give children full access to reach at their favorite teddy or dolly at any time if they like. Kids can look at their toys without taking it away from its place. It is handy and keeps their plaything safe in place. It is secure and handy all times. And always it is a piece of mind for kids.
The stuff animal/dolly holders in back to back stroller it is attached at left side of each child's seats. On single type of strollers the holder is located the right side.
On triple strollers it is attached on both sides of the stroller (right and left). On the back to back double and triples all located on the left sides.
The stuff animal and dolly holders are a piece of metal in half horseshoe shape, which has the flexibility to expand. Then kids can push through and place their teddy/dolly inside to hold safely. It can be pushed back to side of railing when is not used. There is hitch which allows closing the receptacle.

5. Bottom Storage/Cargo Protector: This is a pleasant addition, which protects stroller's cargo bottom from being got ribbed. Has the ability to store more in cargo area without collapsing. The protectors are covered with sleeves and tighten on each edge of the cargo corners.
The Flexie Stroller's bottom storage/cargo protector on claim 2, wherein a piece of two inches wide each cress cross bar at the lower level of the storage area at the bottom of the stroller. This bar protector piece at the storage unit helps the cargo area from being falling on the ground. It gives the user the chance to be able store more item or even heaver items in the storage unit and not to touch the ground.
And it prevents from wearied out.

6. Comfort Pillow/Head Rest: This pillow allows children to feel more restful while taking nap during their travels. It is conveniently located in the back of each child's seat for better support. It is safe for Todd's spine and tiny head to be protected while children are sleeping during the ride. The head support it made if soft fabric matching fabric with the rest part of the stroller. There borders of head support are very soft and cousin and the middle part where child's head is in place also made of soft materials filled with cotton. It is like cults. The pillow must be strong enough to hold child's head. Perhaps it is made of strong type of martial for better and stronger hold. Or a flexible wire to place inside the round on the edge of the cousin would be a great choice to make this process to happen.
The Flexie Strollers' comfort Pillows/head rests on claim 2, wherein most importantly it keeps children's head and neck safe in place during sleeping phase.
The pillow gives users the ability to push it back inside in the back seat when it is not needed. It comes out easily out
The pillows are great use when the seats are more pushed back for better performance. The pillow is very useful addition and defiantly healthy for kids spine during sleep and it is more peaceful.

7. The Flexie Strollers on the above three compounds; Stuff Animals/Dolly Holder, Bottom Storage/Cargo Protector and Comfort Pillow/Head Rest are unique new invention to the world of strollers. They all function in a very especial way to make the look and usefulness of the stroller one of kind. It is can be added one at the time or all at once in one Flexie Stroller.

8. Handle(s) Extensions: The additions on both sides of Handles/Push Handles, where users ride the stroller, which allows the consumers to extend the height of their stroller instead of using leg extensions below. This option gives more convenience ability to adjust the height of stroller as needed. With a click of button on both sides of the handle riders can pull out the handle beneficially height up to two levels about two inches higher then normal standard height.
The Flexie Strollers' Handle(s) Extension on claim 3, there is the piece of metal/little button on each side of the handle is located on the right and the left of the push handle. The handle pole can be pushed/pulled out by pressing the little button down.
This feature allows users to pull or shift the handles towards themselves for more comfortable ride. Also this options can be used instead of the below leg extension or both at the some time for better and more comfortable ride. This function helps people who are taller then average from getting back pain and gives more comfort to stay tall and still ride comfortably.

9. Leg Extensions: This extension is on all wheels front and the back. This addition allows the users to set the height of their strollers according their personal heights as needed. The process functions by a tinny little button on the railings of the each wheel. This little metal button allows the user to adjust the heights up to three levels about two inches taller then current standard height of sixty inches.
The Flexie Strollers' Leg Extension functions on claim 3, wherein there is a piece of metal/little button on each wheel which can be pushed down and it allows the user to adjust the height of the stroller up to three levels higher as needed. If the adjustment is not needed the little buttons can be pushed back or slide in inside to keep the current standard height. This piece of metal/little button on each wheel is located about one inch above each wheel on the side of each wheel.
The Leg Extension is, wherein the each wheel rod is easily can be slide over one another like shower curtain rods. By pushing the button down it allows user to extend the height of their Flexie Strollers.

10. The Flexie Strollers on claim 3, wherein the Handles Extensions and Push Bar Extensions are do function and operate the same way. It also can be added to stroller both at once or one at the time.
